(19) United States
(12) Patent Application Publication
(10) Pub. No.: US 2023/0169432 A1
(43) Pub. Date: Jun. 1, 2023

(54) Record Generation for Execution of Process Workflows

(71) Applicant: ServiceNow, Inc., Santa Clara, CA (US)

(72) Inventors: Oleg Todorenko, San Diego, CA (US); Joseph Grant Plaster, San Diego, CA (US); Yaron Guez, San Diego, CA (US); Michael Chance, San Diego, CA (US)

(21) Appl. No.: 17/537,960

(22) Filed: Nov. 30, 2021

(51) Int. Cl. G06Q 10/06; G06F 16/903

(52) U.S. Cl. CPC G06Q 10/06316; G06F 16/90335

(57) ABSTRACT

A system and method for generation of records for execution of process workflows is provided. The system receives a first input associated with a record creation activity and extracts process execution data associated with the process workflow and configuration data associated with the record creation activity from one or more database tables. The system controls the electronic device to render a second UI based on the configuration and process execution data. The second UI includes a record creation form and a set of UI elements to represent activities associated with the process workflow in a pending state of execution. The system further receives a second input and triggers execution of the activities based on the received second input. The set of UI elements on the second UI are updated based on the triggered execution to represent at least one of the activities in an executional state.

### FIELD

Various embodiments of the disclosure relate to processes, process workflows, and enhancement of user experience for process workflow execution. More specifically, various embodiments of the disclosure relate to a system and method for record generation for execution of process workflows.

### BACKGROUND

Organizations typically have multiple processes running at any point in time. Such processes have associated workflows, many of which can be executed in a digital environment, such as an enterprise server. A process can be defined as an activity or a set of activities that accomplish a specific objective or an organizational goal. For instance, in the banking industry, a process can be a customer on-boarding process or a credit check process for loan approval or credit card issuance.

The process workflow can include multiple interdependent activities which a user or a group of users may complete to reach a result. The organizations typically execute the process workflows to find one or more inefficiencies in the process, to streamline the activities, to achieve resource optimization associated with the process, and to offer suitable services to their employees, affiliates, or customers. Typically, the process workflow will not be triggered until an initial record has been created or updated for the associated process. Traditional methods for creation of the record can involve activities, such as filling up a lengthy record creation form in multiple steps. Some fields in the record creation form can be dependent on previous fields. Also, some steps can involve creation of sibling records or child records as well as dynamic user actions that may be backed by conditions for triggering the process workflow associated with the process. Due to these complex and lengthy steps, the record creation process can be cumbersome, time-consuming, and subject to human error.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method for record generation for execution of process workflows is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram of an exemplary network environment for record generation for execution of process workflows, in accordance with an embodiment of the disclosure.

FIG. 2 is a block diagram of a system for record generation for execution of process workflows, in accordance with an embodiment of the disclosure.

FIG. 3 is a diagram that illustrates an example record generator configuration user interface (UI) for configuration of record generation for execution of process workflows, according to at least one embodiment described in the present disclosure.

FIG. 4 is a diagram that illustrates an exemplary scenario for record generation for execution of process workflows, in accordance with an embodiment of the disclosure.

FIG. 5 illustrates exemplary operations for record generation for execution of process workflows, in accordance with an embodiment of the disclosure.

FIG. 6A is a diagram that illustrates an example second user interface (UI), according to at least one embodiment described in the present disclosure.

FIG. 6B is a diagram that illustrates an example second user interface (UI) with updated set of UI elements, according to at least one embodiment described in the present disclosure.

FIG. 7 is a flowchart that illustrates an exemplary method for record generation for execution of process workflows, in accordance with an embodiment of the disclosure.

### DETAILED DESCRIPTION

The following described implementations may be found in a disclosed system and method for generation of records for execution of process workflows. Traditionally, organizations have a variety of processes. Each process is an activity or a set of activities that accomplishes a specific organizational goal. For example, in the banking industry, the process may correspond to a customer on-boarding process, a credit check process, and so on. Each process can be unique and can have its own level of complexity, criticality, and impact on the organization. Each process may have an associated process workflow (or workflow). The process workflow may include a set of tasks that can be carried out sequentially (i.e. in a step-by-step manner) based on one or more user-defined rules or conditions. The process workflow may also include data and rules that support the set of tasks to be completed to achieve the objective of the process.

Typically, applications that execute process workflow require an initial record in a database to trigger or initiate the process workflow. The steps of the process workflow may be triggered (e.g., enabled and/or displayed) only after the initial record is created or is found in a table/database associated with the process workflow. The record creation is typically done by manually filing a form. The process of filling the form can be tedious as it can include a large number of input fields. In some scenarios, some of these fields can be dependent on data input in previous fields. In some other scenarios, the steps involve creation of one or more child records or sibling records, and dynamic user actions that may be backed by conditions. Due to all these reasons, the current record creation process may be tedious, time-consuming and requires multiple (and sometimes repetitive) user inputs. As the user has to manually fill the form, the entire process of filling the form may be cumbersome for the user, especially in cases where the user has to switch between a record creation user interface (includes the form) and a user interface for process workflow execution. This may likely affect the user experience as the user may have to fill the form every time the process workflow has to be executed.

The disclosed system may dynamically insert a record creation activity, as an initial activity, within the process workflow based on configuration from an administrator. The record creation activity may include a record creation form with minimal count of fields. Many fields in the record creation form may be pre-filled based on the configuration done by the administrator. The user may be required to select a button within the record creation form and the record may be created in the table associated with the process work. Based on the creation of the record, a first activity of the process workflow may be triggered automatically. This may drastically reduce the time consumption done in the traditional approaches. Moreover, this may also reduce human errors that were prevalent in the traditional approaches, as most of the fields in the record creation form may be pre-filled.

When the user selects an option to trigger a process workflow, the disclosed system may redirect the user to a user interface that includes the record creation form as a first activity followed by all activities of the process workflow. Instead of displaying a separate user interface for the record creation form, the disclosed system may dynamically insert the record creation form in the user interface so that the user may have to never leave the user interface while working on the process workflow. All remaining activities of the process workflow may be represented to be in a pending state while the user completes the record creation activity. As soon as the user submits the record creation form, one or more activities of the process workflow execution may be triggered. The pending state of the remaining activities may be updated to represent an “in-progress” state of execution.

The record creation activity may appear to be triggered, and the record creation form may be displayed to the user as soon as the user lands on the user interface for process workflow execution. This may enhance the user experience as the user may be made to believe that process workflow has been started. Whereas in reality, the process workflow is not actually triggered until the first activity is completed. All of the subsequent activities within the process workflow may be shown to be pending and dependent on this record creation activity. After filling up the record creation form and clicking on the button, the dynamically inserted record creation activity may be shown to be “Complete”. This may provide the user with a seamless experience as compared to traditional approaches.

Exemplary aspects of the disclosure provide a system that may include a processor. The system may receive a first input associated with a record creation activity via a first user interface (UI) on an electronic device (or a user device). The record creation activity may be required to trigger a process workflow. The system may further extract process execution data associated with the process workflow and configuration data associated with the record creation activity from one or more database tables. The extraction may be performed based on the received first input. The system 102 may further control the electronic device to render a second UI based on the process execution data and the configuration data. The second UI may include a record creation form and a set of UI elements to represent activities associated with the process workflow in a pending state of execution. The system may further receive a second input via the record creation form of the second UI and trigger execution of the activities based on the received second input. The system may further update the set of UI elements on the second UI based on the triggered execution to represent at least one of the activities in an executional state.

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized, and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways. Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

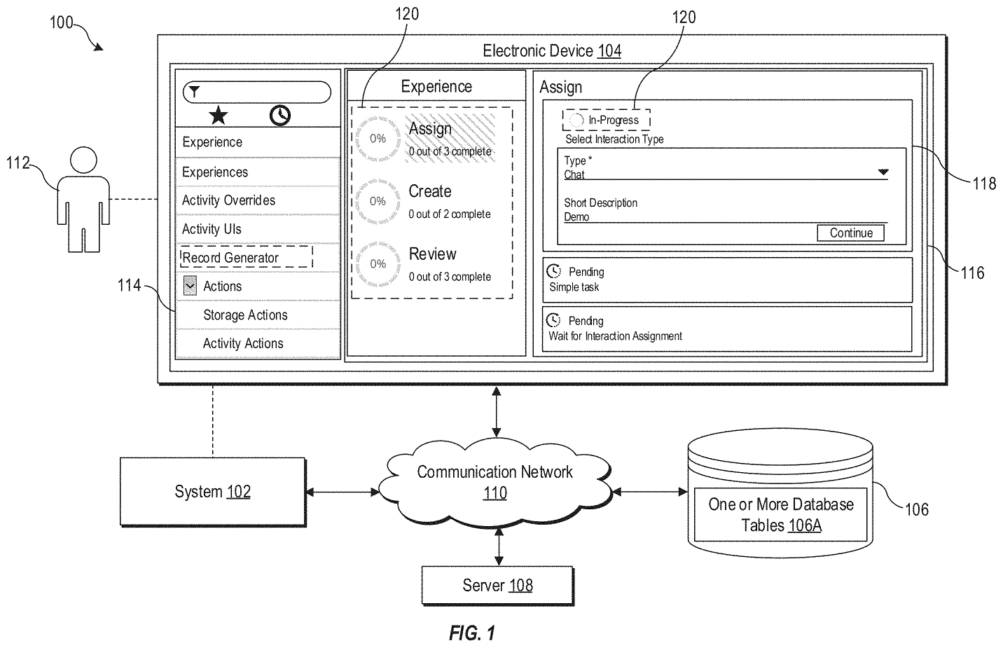

FIG. 1 is a diagram of an exemplary network environment for generation of record for execution of process workflows, in accordance with an embodiment of the disclosure. With reference to FIG. 1, there is shown a block diagram of a network environment 100. The network environment 100 may include a system 102, an electronic device 104, a database 106 that may include one or more database tables 106A, and a server 108. The system 102 may be configured to communicate with the electronic device 104 and the server 108 through a communication network 110. With reference to FIG. 1, there is further shown an end-user 112, a first user interface (UI) 114, and a second UI 116. The second UI 116 may include a record creation form 118 and a set of UI elements 120.

The system 102 may include suitable code, logic, circuitry, and/or interfaces that may be configured to control the electronic device 104 to render a user interface (such as the second UI 116) that includes the record creation form 118 and the set of UI elements 120 to represent activities associated with the process workflow. Initially, the activities may be represented in a pending state of execution. The system 102 may be further configured to trigger execution of the activities based on an input via the record creation form 118 of the second UI 116. Example implementations of the system 102 may include, but are not limited to, a cloud server (public, private, or hybrid), a distributed computing server or a cluster of servers, a Software-as-a-Service (SaaS) application server, an edge computing system that includes a network of distributed compute/edge nodes), a mainframe system, a work-station, a personal computer, or a mobile device.

In an exemplary embodiment, the system 102 may include a frontend subsystem and a backend subsystem. The frontend subsystem may be part of a client-side code or application, executable on user devices (such as the electronic device 104), IT terminals, or electronic devices associated with provider of the websites or the web applications. The frontend subsystem may be configured to execute at least one operation on the electronic device 104 to render the first UI 114 and the second UI 116, and to allow end-users (including the end-user 112) or customers, IT admins, or website operators to provide inputs. The frontend subsystem may be deployed on several web-clients, such as web browsers, each of which may be associated with a network of electronic devices (including the electronic device 104). The backend subsystem may include a server-side application, which may execute operations related to triggering of the execution of the activities based on received input(s).

The electronic device 104 may include suitable logic, circuitry, and interfaces that may be configured to render the first UI 114 and the second UI 116. The electronic device 104 may be associated with the end-user 112. In an embodiment, the electronic device 104 may be further configured to receive a first input and a second input from the end-user 112. While the first input may be provided to initiate a record creation activity and the second input may be provided to fill and submit the record creation form 118. Examples of the electronic device 104 may include, but are not limited to, a computing device, a smartphone, a mobile computer, a gaming device, a wearable display device (such as an eXtended Reality (XR) device), a mainframe machine, a server, a computer work-station, and/or a consumer electronic (CE) device.

The database 106 may include suitable logic, circuitry, and interfaces, and/or code that may be configured to store the one or more database tables 106A. The one or more database tables 106A may store process execution data associated with the process workflow and configuration data associated with the record creation activity. In an embodiment, the process execution data may be stored in a first database table of the one or more database tables 106A and the configuration data may be stored in a second database table of the one or more database tables 106A. Each the one or more database tables 106A may be managed by a database management system.

The database 106 may be implemented as a relational database with a defined schema or a non-relational database, such as a NoSQL (Structured Query Language) database that supports key-value and document data structures. In an embodiment, the database 106 may be a cloud database which may be accessible as-a-service on the system 102.

The server 108 may include suitable logic, circuitry, and interfaces, and/or code that may be configured to store inputs (such as a first input and a second input from the end-user 112). In an embodiment, the server 108 may be also configured to store the one or more database tables 106A, input(s) from admin(s) who setup the record creation activity and/or design a process workflow, an object graph, and a declarative action associated with a button UI element. The server 108 may be implemented as a cloud server may execute operations through web applications, cloud applications, HTTP requests, repository operations, file transfer, and the like. Other example implementations of the server 108 may include, but are not limited to, a database server, a file server, a web server, a media server, an application server, a mainframe server, or a cloud computing server.

In at least one embodiment, the server 108 may be implemented as a plurality of distributed cloud-based resources by use of several technologies that are well known to those ordinarily skilled in the art. A person with ordinary skill in the art will understand that the scope of the disclosure may not be limited to the implementation of the server 108 and the system 102 as two separate entities. In certain embodiments, the functionalities of the system 102 can be incorporated in its entirety or at least partially in the server 108, without a departure from the scope of the disclosure.

The communication network 110 may include a communication medium through which the system 102, the electronic device 104, the database 106, and the server 108 may communicate with each other. The communication network 110 may include one of a wired connection or a wireless connection. Examples of the communication network 110 may include, but are not limited to, the Internet, a cloud network, a Wireless Fidelity (Wi-Fi) network, a Personal Area Network (PAN), a Local Area Network (LAN), a mobile wireless network (such as 5G New Radio), or a Metropolitan Area Network (MAN). Various devices in the network environment 100 may be configured to connect to the communication network 110 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), International Mobile Telecommunications-2020 (IMT-2020), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT)® communication protocols.

In operation, the end-user 112 may wish to execute a process workflow associated with a process. To execute the process workflow, a record may have to be created. The system 102 may be configured to receive a first input associated with a record creation activity, via the first UI 114. As shown, for example, an option for “Record Generator” on the first UI 114 may be selected by the end-user 112 via the first input. The record creation activity may be required to create a record that may be further required to trigger a process workflow associated with a process. The process may be an organizational process that may require an activity or a set of activities to be accomplished/completed to achieve a specific goal or objective. The goal may be a department-specific goal or may be an organizational goal, for example, profit maximization, customer satisfaction, and the like. The process may be categorized into, but are not limited to, a primary process, a support type process, and a management process. The primary process may be important and fundamental for the organization. Examples of the primary process may include a sales process, a finance process, a customer service process, an operations process, a production process, and the like. The support type process may correspond to a process that may create a suitable environment for the functioning of the primary processes. However, such a process may not be involved in a delivery of a final product to one or more client of the organization. Examples of the support type process may include an accounting process, a management process, a human resource management process, and the like. The management process may be concerned with an orientation and monitoring and analyzing the day to day activities in the organization. In banking industry, examples of such management processes may include a customer on-boarding process, a credit check process, and so on.

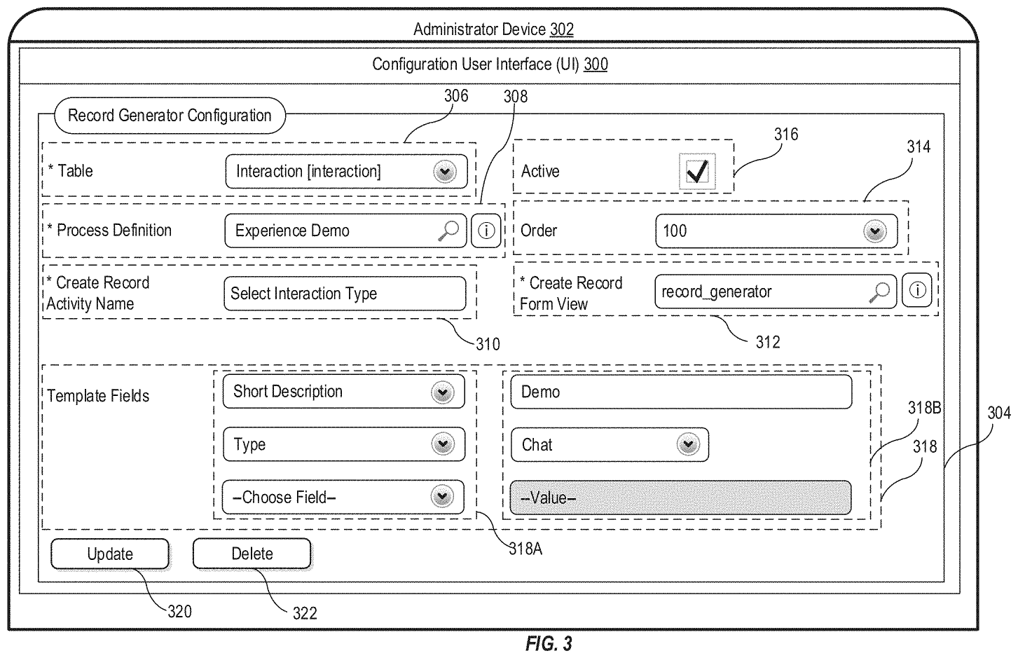

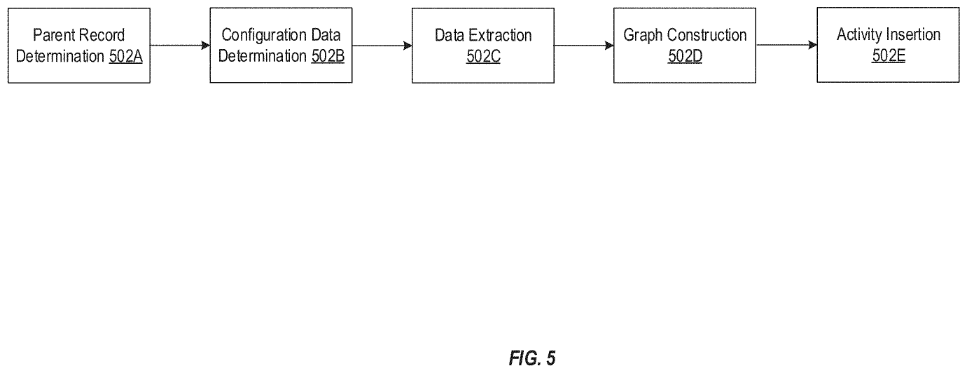

The system 102 may be further configured to extract process execution data associated with the process workflow and configuration data associated with the record creation activity. The extraction may be performed based on the received first input. In an embodiment, the process execution data and the configuration data may be extracted from the one or more database tables 106A. The process execution data may include activities associated with the process workflow. The configuration data may be associated with a configuration of the record creation form 118. Details about the process execution data and the configuration data are provided, for example, in FIG. 3 and FIG. 5.

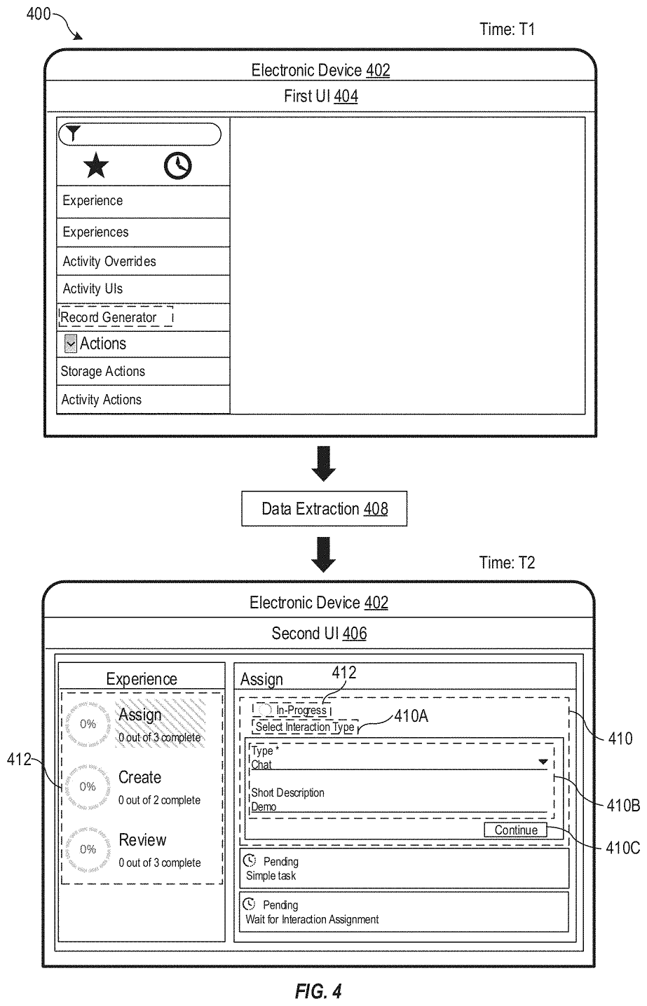

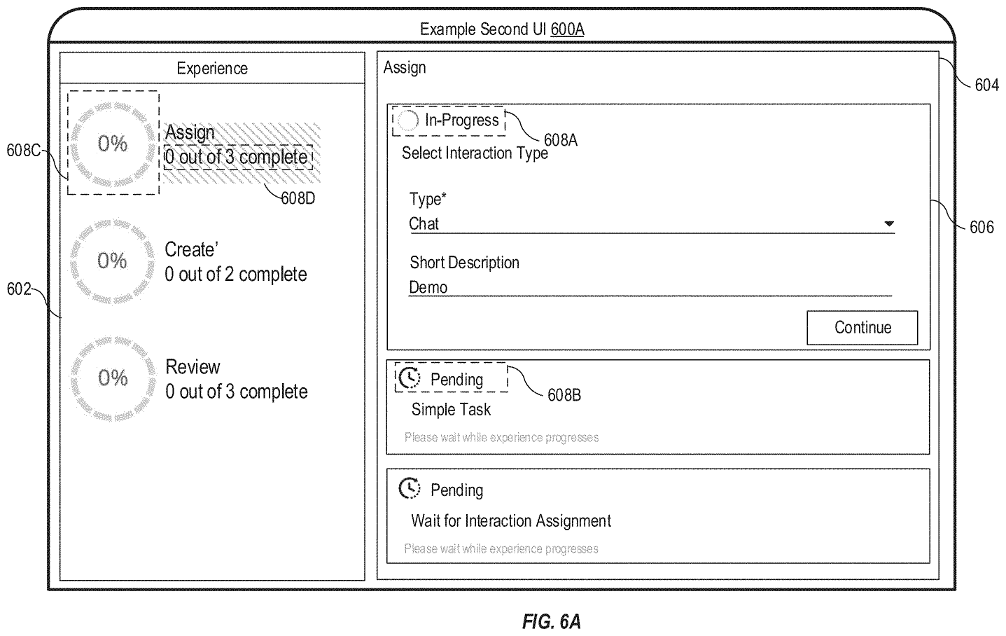

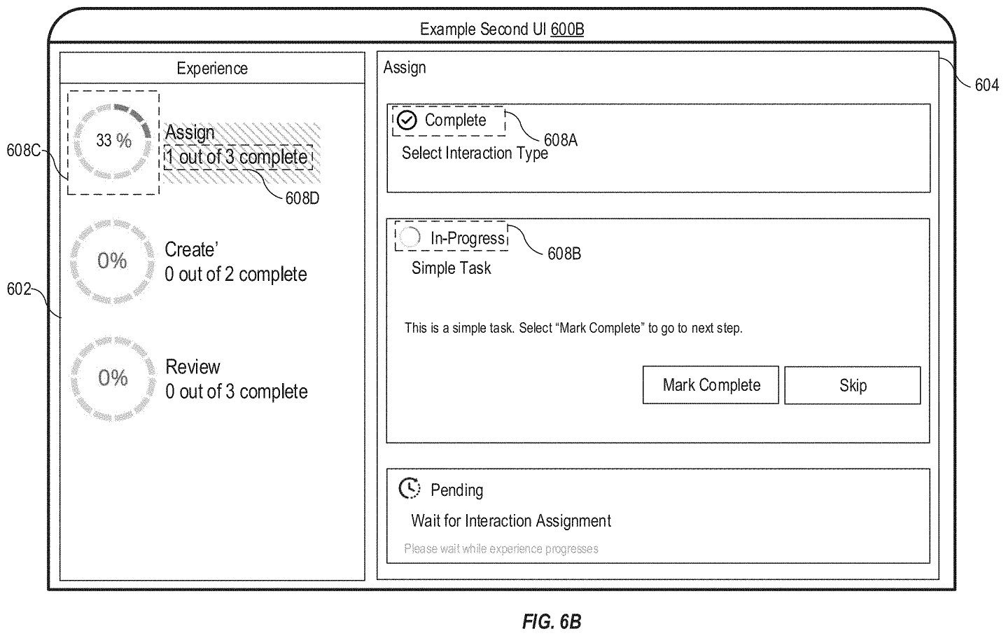

The system 102 may be further configured to control the electronic device 104 to render the second UI 116. The second UI 116 may be rendered based on the extracted process execution data and the extracted configuration data. The second UI 116 may include the record creation form 118 and the set of UI elements 120 to represent activities associated with the process workflow in a pending state of execution. The record creation form 118 may be filled to complete the record creation activity. Details about the record creation form are provided, for example, in FIG. 4, and FIG. 6A.

The system 102 may be further configured to receive a second input via the record creation form 118 of the second UI 116. The second input may correspond to a selection of button UI element (i.e. “Continue” button) that may be a declarative action to submit the record creation form 118. The system 102 may be configured to generate a record based on the reception of the second input. Based on the generation of the record, the system 102 may be further configured to trigger execution of the activities in the process.

The system 102 may be further configured to update the set of UI elements 120 on the second UI 116 based on the triggered execution. The set of UI elements 120 may be updated to represent at least one of the activities in an executional state. For example, the second UI 116 may include at least one progress bar associated with each activity and may indicate a progress of the corresponding activity. For example, before the reception of the second input, the progress bar associated with the “Select Interaction Type” activity may indicate “In-Progress” and the progress bar associated with a “Simple Task” may indicate “Pending”. After the reception of the second input, the progress bar associated with the “Select Interaction Type” activity may indicate “Completed” and the progress bar associated with a “Simple Task” may indicate “In-Progress”. Also, the progress bar that may appear on the left side and may be associated with the “Assign” state may be updated from “0%” to “33%” and “0 out of 3 complete” to “1 out of 3 complete”.

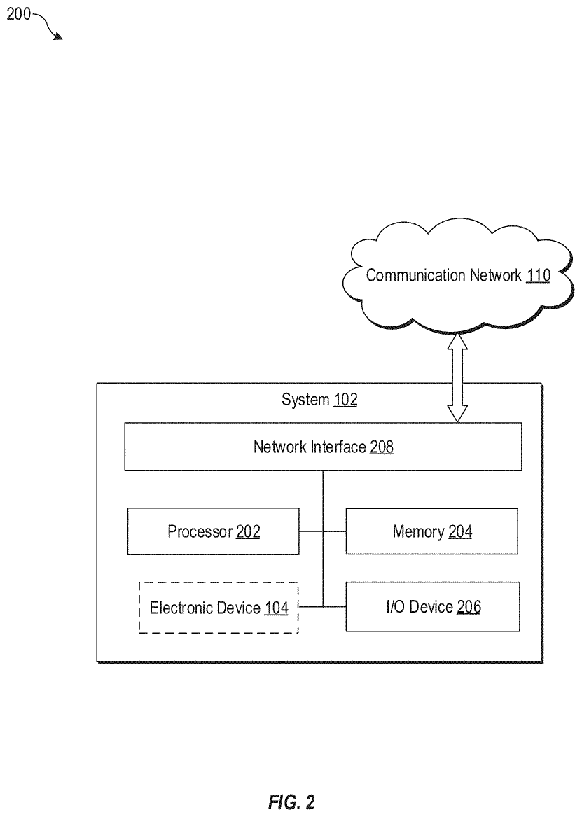

FIG. 2 is a block diagram of a system for generation of records for execution of process workflows, in accordance with an embodiment of the disclosure. FIG. 2 is explained in conjunction with elements from FIG. 1. With reference to FIG. 2, there is shown a block diagram 200 of the system 102. The system 102 may processor 202, a memory 204, an input/output (I/O) device 206, and a network interface 208. As shown, for example, the system 102 may include the electronic device 104.

The processor 202 may include suitable logic, circuitry, interfaces, and/or code that may be configured to execute instructions associated with operations that may have to be executed by the system 102. For example, some of the operations may include reception of the first input, extraction of the process execution data and configuration data, rendering of the second UI 116 and further trigger the execution of the activities based on the received second input associated with the record creation form 118. Example implementations of the processor 202 may include, but are not limited to, a Central Processing Unit (CPU), x86-based processor, a Reduced Instruction Set Computing (RISC) processor, an Application-Specific Integrated Circuit (ASIC) processor, a Complex Instruction Set Computing (CISC) processor, a Graphical Processing Unit (GPU), co-processors, other processors, and/or a combination thereof.

The memory 204 may include suitable logic, circuitry, code, and/or interfaces that may be configured to store the instructions executable by the processor 202. For instance, the memory 204 may store the received first input, the received second input, the extracted process execution data, and the extracted configuration data. The memory 204 may be further configured to store the first admin input, the second admin input, the object graph, a name of the record creation activity, a pre-filled entry included in one or more template fields, and a declarative action associated with a button UI. Examples of implementation of the memory 204 may include, but are not limited to, Random Access Memory (RAM), Read Only Memory (ROM), Hard Disk Drive (HDD), and/or a Secure Digital (SD) card.

The I/O device 206 may include suitable logic, circuitry, and/or interfaces that may be configured to receive one or more inputs and provide an output based on the received one or more inputs. The first input and the second input and/or a first admin input and a second admin input may be received via the I/O device 206. The I/O device 206 may include various input and output devices, which may be configured to communicate with the processor 202. Examples of the I/O device 206 may include, but are not limited to, a touch screen, a keyboard, a mouse, a joystick, a display device, a microphone, or a speaker.

The network interface 208 may include suitable logic, circuitry, and interfaces that may be configured to facilitate communication between the processor 202, the electronic device 104, and the server 108 (or any other device in the network environment), via the communication network 110. The network interface 208 may be implemented by use of various known technologies to support wired or wireless communication of the system 102 with the communication network 110. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The functions or operations executed by the system 102, as described in FIGS. 1, 3, 4, 5, 6A, 6B, and 7 may be performed by the processor 202.

FIG. 3 is a diagram that illustrates an example user interface (UI) for configuration of record generation for execution of process workflows, according to at least one embodiment described in the present disclosure. FIG. 3 is explained in conjunction with elements from FIG. 1 and FIG. 2. With reference to FIG. 3, there is shown a record generator configuration UI 300 that may be displayed on an administrator device 302 based on an admin request, which may be received via an application interface displayed onto a display screen of the administrator device 302. The application interface may be part of an application software, for example, a software development kit (SDK), a cloud server-based application, a web-based application, an OS-based application/application suite, an enterprise application, a mobile application for configuration of record generation activity.

In an embodiment, the system 102 may operate in a set-up mode and in an execution mode. In the set-up mode, the system 102 may be receive configuration data associated with a configuration of the record creation from 118. In the execution mode, the system 102 may be configured to render the record creation form 118 on the second UI 116 based on the configuration data received during the set-up mode. During the set-up mode, the system 102 may receive one or more admin inputs from an administrator. The administrator may be an Information Technology (IT) administrator, an owner or a manager of a process, an individual with a defined role-based access. During the execution mode, the system 102 may receive one or more inputs from an end-user (such as the end-user 112). The end-user 112 may be any person who is supposed to complete the activities of a process (e.g., an onboarding process in a company) in an organization.

During the set-up mode, the system 102 may be configured to control the administrator device 302 to render the record generator configuration UI 300. The administrator device 302 may be associated with the administrator and may include suitable logic, circuitry, and interfaces that may be configured to render the record generator configuration UI 300.

In an embodiment, the administrator device 302 may be configured to receive one or more admin inputs from the administrator. Examples of the administrator device 302 may include, but are not limited to, a computing device, a computer work-station, a server, a smartphone, a mobile computer, a gaming device, a wearable display device (such as an eXtended Reality (XR) device), a mainframe machine, and/or a consumer electronic (CE) device.

On the record generator configuration UI 300, there is shown a UI element 304 that may be labelled as “Record Generator Configuration”. The UI element 304 may include a table menu 306, a process definition textbox 308, a create record activity name textbox 310, a create record form view textbox 312, an order textbox 314, an active checkbox 316, and one or more template fields 318 that include a first menu 318A and a second menu 318B. There is further shown a first UI element 320 and a second UI element 322.

The system 102 may be configured to receive a first admin input via a record generator configuration UI 300 rendered on the administrator device 302. Through the table menu 306, the process definition textbox 308, the create record activity name textbox 310, the create record form view textbox 312, the order textbox 314, the active checkbox 316, the first menu 318A, the second menu 318B, and the first UI element 320, and/or the second UI element 322, the system 102 may receive the first admin input associated with the configuration of record creation activity. Specifically, the first admin input may include values for the table menu 306, the process definition textbox 308, the create record activity name textbox 310, and the create record form view textbox 312, and/or the order textbox 314, and/or the active checkbox 316, and/or the first menu 318A, and/or the second menu 318B, and/or the first UI element 320, and/or the second UI element 322.

The table menu 306 may be a drop-down menu that may display a name of a plurality of tables for which the new record page should use the record generator entry. The process definition textbox 308 may be a textbox where the administrator may add a name of the process definition to show to the end-user 112 before the record is created. The process definition may be associated with the process workflow and may be required to execute the process workflow. The process definition may include a trigger, a set of lanes, and activities associated with the process. The trigger may include a set of conditions for triggering the process workflow. Each lane of the set of lanes may represent one stage of the process and may include one or more activities associated with the process. On the second UI 116, all activities except the record creation form 118 in the process workflow may be marked as pending. In case no process is executed after the record has been created, the system 102 may be configured to manually trigger the process definition.

The create record activity name textbox 310 may be a textbox in which the administrator may add a name for the record creation activity that may be inserted as a first step to be executed within the specified process definition. The create record form view textbox 312 may be a textbox in which the administrator may add a name of a form view that may be used for the new record form to be embedded within the inserted record creation activity. A form view of the record creation form 118 may be configured based on the value of the create record form view textbox 312.

The order textbox 314 may be a textbox in which the administrator may add an integer value that may determine a precedence of current configuration in relation to other activities associated with the process workflow. In an embodiment, a lower number may indicate that the current configuration will be selected over other configurations. The active checkbox 316, when selected, may activate the record generator. The first menu 318A and the second menu 318B may be drop-downs and/or textboxes, in which the administrator may select and/or add template fields. The selected templated fields may be pre-filled in the record creation form 118.

The first UI element 320 may be labelled as, for example, “Update” and may be a button. Upon a selection of the first UI element 304, the system 102 may update and/or store the configuration data in the memory 204 of the system 102. The second UI element 322 may be labelled as, for example, “Delete” and may be a button. Upon a selection of the second UI element 322, the system 102 may delete all the values that the administer may add via the first admin input. This may enable the administration to provide the first admin input again.

Based on the reception of the first admin input, the system 102 may be configured to update a record generator table of the one or more database tables 106A with the configuration data received based on the first admin input. As discussed, the configuration data may include the name of the table in which the record is to be inserted, the process definition of the process workflow, the name of the record creation activity, the name of the record creation form 118, and one or more template fields to be provided in the record creation form 118.

In an embodiment, the system 102 may be configured to receive a second admin input that may be associated with a configuration of a button UI element that may be present in the record creation form 118. The button UI element may be a declarative action to submit the record creation form 118. The configuration of the button UI element may be associated with at least one action of a list of actions that may be executed upon a selection of the button UI element. The list of actions may include at least one of a set of user interface (UI) actions, a set of client actions, and a set of server actions.

Each UI action of the set of UI actions may be performed on one or more UI elements in the second UI 116. The set of UI actions, for example, a modification of a value of a pre-filled template field in the record creation form 118, a freezing of a field in the record creation form 118, a loading of one or more new UI elements within the second UI 116, and the like. Each client action of the set of client actions may perform an action on the second UI 116. Examples of set of client actions may include, but are not limited to, dialing a phone number, opening a record, opening a form to modify record content, and opening a URL. Each of the set of server actions may execute a script on a server (or the database 106) that stores the one or more database tables 106A to change one or more contents of the one or more database tables 106A. Examples of the set of server actions may include, but are not limited to, assigning a record to an agent, deleting a record from a first database table of the one or more database tables 106A, or adding a record to the first database table. In an embodiment, the values in the first admin input and the second admin input may be collectively referred to as configuration data.

In an embodiment, the record creation form 118 may be displayed to the end-user 112 only if the executing process is same as the process definition of the process workflow, as specified by the administrator via the process definition textbox 308. The record creation form 118 may not be displayed to the end-user 112 if the executing process is different from the process definition of the process workflow, as specified by the administrator via the process definition textbox 308.

In another embodiment, the record generator configuration UI 300 may include a third UI element that may be labelled as “Insert activity into running playbooks” and maybe a dropdown list. The third UI element may have three options i.e. “If process definition matches (default)”, “Never”, and “Always”. The third UI element may be used to insert the record creation activity in the process. The third UI element may provide flexibility to the administrator to choose to whether to always insert the record creation activity or never insert the record creation activity, depending on a use case. This may support situations in which different process definitions might be triggered after the record is created, depending on input(s) from the end-user 112. In an embodiment, a parent process definition may be specified in the record creation activity that may have common steps in each of one or more child process definitions. This parent process may be shown before the record is created. After the record is created, one of the child process definitions may be executed based on one or more inputs provided by the end-user 112 in the record creation activity. The parent process may be shown to the end-user 112 before the record is created. The end-user may enter one or more specific values in the record creation form 118 that may trigger a specific child process. In an embodiment, after triggering the execution of the specific child process, no completed record creation activity may be inserted because the record creation activity may not match the parent process definition. In another embodiment, the administrator may be able to configure the completed record creation activity to show the record creation activity after the execution of each child process.

It should be noted here that the UI elements shown in FIG. 3 are presented merely as examples and such examples should not be construed as limiting the disclosure. The present disclosure may include more or less UI elements and the appearance, position, and UI type may differ in comparison to the UI elements shown in FIG. 3, without departing from the scope of the disclosure.

FIG. 4 is a diagram that illustrates an exemplary scenario for record generation for execution of process workflows, in accordance with an embodiment of the disclosure. FIG. 4 is explained in conjunction with elements from FIGS. 1, 2, and 3. With reference to FIG. 4, there is shown an exemplary scenario 400. In the exemplary scenario 400, there is shown an electronic device 402. Within the electronic device 402, there is further shown a first user interface (UI) 404 at time T₁. At time T₂, a second user interface (UI) 406 may be displayed on the electronic device 402.

At time T₁, the system 102 may be configured to receive a first input associated with a record creation activity. The first input may be received from the end-user 112 via the first UI 404 that may be displayed on the electronic device 402. The record creation activity may be required to trigger a process workflow. The process workflow may be associated with a process or any other organizational process. The process may correspond to a set of related, structured activities (or tasks) which in a specific sequence produces a service or product (that may serve a particular goal) for a particular group of customers, affiliates, and/or employees. Each activity may be defined using a set of instructions and include, for example, a computer-executable script/code, logging, an approval, a record processing activity, a timer, a wait time, and the like. One or more first activities of the set of activities may process inputs from one or more second activities of the set of activities. Also, the one or more first activities may provide an output that may be consumed by one or more second activities as input.

For example, in an advertisement company, the process associated with creation of an advertisement may include a set of activities, such as understanding client requirements, brainstorming an idea for the advertisement, preparing a campaign, pitching the idea to the client, getting the approval, making necessary changes, and providing the deliverables to the client. Similarly, in information technology, the process for developing a product may include activities, such as, but not limited to, understanding market demand, finalizing a product outline, programming the backend, coordinating with the designer to program the front end and the UX (User eXperience), testing the product internally, solving bugs, and errors, running a beta test, taking feedbacks from the users, and improving further.

The process workflow may correspond to a repeatable pattern of the activities that may take place to complete a particular objective or a goal. In an embodiment, the process workflow may include activities that can be carried out based on one or more user-defined rules or conditions. In an embodiment, the process workflow may correspond to a collection of data, rules, and activities that need to be completed to achieve the objective or the goal. By way of example, and not limitation, the process workflow associated with leave approval of an employee in an organization may include the employee filling out a digital vacation request form and sending the same to a corresponding manager electronically, the manager approving the request, and the request being routed to human resource department and payroll department.

As previously discussed, the first input may be associated with the record creation activity. The record creation activity may be a virtual activity within the process. In an embodiment, the system 102 may automatically create the record creation activity based on the reception of the first admin input and the second admin input, as described in FIG. 3. The system 102 may be further configured to insert the record creation activity as an initial activity of the activities associated with the process workflow based on the reception of the first admin input and the second admin input. The record creation activity may be associated with creation of a record that may trigger the process workflow. Specifically, the record creation activity may be associated with creation of the record that may trigger first activities associated with the process workflow.

In an embodiment, the first input may correspond to selection of the “Record Generator” option within the first UI 404. Based on the reception of the first input, the system 102 may be configured to perform a data extraction operation. Details about the data extraction operation are provided herein.

At 408, a data extraction operation may be performed. In the data extraction operation, the system 102 may be configured to extract process execution data and configuration data from the one or more database tables 106A, based on the received first input. The process execution data may be associated with the process workflow and the configuration data may be associated with the record creation activity. Specifically, the process execution data may be associated with the process. In an embodiment, the process execution data may be part of a process definition of the process workflow. As discussed earlier, the process definition may be specified in the first admin input. Details about the process definition and extraction of the process execution data and the configuration data are provided, for example, in FIG. 5.

At time T₂, the system 102 may be configured to control the electronic device 402 to render the second UI 406 based on the process execution data and the configuration data. The second UI 406 may include a record creation form 410 and a set of UI elements 412. The record creation form 410 may be displayed to complete the record creation activity. The set of UI elements 412 may represent activities associated with the process workflow in a pending state of execution. For example, the set of UI elements 412 may include one or more progress bars that may indicate a progress of an activity (or a task within the activity). In an embodiment, each of the one or more progress bars of the set of UI elements 412 may be created using Hypertext Mark-up Language (HTML) progress tags.

The record creation form 410 may include a form view that may include one or more fields. Specifically, the record creation form 410 may include the form view that includes a name 410A of the record creation activity, one or more template fields 410B including at least one pre-filled entry, and a button UI element 410C.

In an embodiment, the name 410A of the record creation form 410 may be provided by an administrator via the first admin input, for example, at 310. As displayed in FIG. 4, the name 410A of record creation form 410 within the form view may be “Select Interaction Type”. The one or more template fields 410B with pre-filled entry may be based on the first admin input at 318. As displayed in FIG. 4, the one or more template fields 410B may be “Type”: “Chat”, and “Short Description”: “Demo”. The button UI element 410C may be the declarative action to submit the record creation form 410 that may be triggered based on a selection of the button UI element 410C. In an embodiment, a list of actions may be executed based on the selection of the button UI element 410C. A particular action to be executed based on the selection of the button UI element 410C may be based on the configuration of the button UI element 410C. The configuration of the button UI element 410C may be based on the second admin input. Details about the first admin input and the second admin input are provided, for example, in FIG. 3.

The system 102 may be further configured to receive a second input. The second input may be received via the record creation form 410 of the second UI 406. In an embodiment, the second input may be received via button UI element 410C in the record creation form 410 and may correspond to a selection of the button UI element 410C. Based on the reception of the second input, the system 102 may be configured to generate a record. The generated record may include the name 410A of record creation form 410 and the one or more template fields 410B. The system 102 may be further configured to insert the generated record as a parent record in a table associated with the process workflow. The system 102 may be further configured to trigger execution of the activities based on the insertion of the record in the table associated with the process workflow.

In certain instances, the end-user 112 may want to change at least one pre-filled entry in the one or more template fields of the record creation form 410. In such instances, the system 102 may receive a second input associated with at least one new value to replace the one pre-filled entry. In certain other instances, the value of at least one pre-filled entry in the one or more template fields of the record creation form 410 may be updated with one or more changes in a uniform resource locator (URL) of the second UI 406 (or the record creation form 410). The at least one new value may be provided in the URL of the of the second UI 406 (or the record creation form 410).

At time T₃, the system 102 may be configured to update the set of UI elements 412 on the second UI 406 based on the triggered execution. The set of UI elements 412 may be updated to represent at least one of the activities in an executional state. For example, at time T₂, the state of a first UI element of the set of UI elements 412 may be changed from “In-progress” to “complete” after the triggered execution. Details about the updated set of UI elements are provided, for example, in FIG. 6B.

In certain instances, the end-user 112 may want to update the record created via the record creation form 410. This may be done with the help of the declarative action(s) performed via the button UI element within the record creation form 410. To provide such facility to update the record, the system 102 may be configured to receive a third input to create an activity action of type “Server Script” and use a client condition builder to apply the created activity action to activities with an “activity type” of “Record” and an “activity state” of “Complete”.

It should be noted that when the record creation form is initially submitted and the record is created, the corresponding activity (i.e. the record creation activity) may become an activity with the “activity type” of “Record”. Because the record creation activity could be associated with the record created via the record creation form, the system 102 may associate the record creation activity with “activity type” of “record”. The activity action may be created via the activity action UI that may include a plurality of UI elements. The system 102 may receive one or more values for at least one UI element of the plurality of UI elements and may create the activity action of type “Server Script” based on the received one or more values. In an embodiment, the server script may correspond to a function “current.update( );” that may be executed based on the selection of the button UI element. The plurality of UI elements may also include one or more textboxes that may allow to input correct values of the pre-filled entries. Based on the execution of the activity action, the pre-filled entries may be updated with the correct values specified in the activity action.

It should be noted here that the UI elements shown in FIG. 4 are presented merely as examples and such examples should not be construed as limiting the disclosure. The present disclosure may include more or less UI elements and the appearance, position, and UI type may differ in comparison to the UI elements shown in FIG. 4, without departing from the scope of the disclosure.

FIG. 5 illustrates exemplary operations for generation of records for execution of process workflows, in accordance with an embodiment of the disclosure. FIG. 5 is explained in conjunction with elements from FIGS. 1, 2, 3, and 4. With reference to FIG. 5, there is shown a block diagram 500 that illustrates exemplary operations from 502A to 502E, as described herein. The exemplary operations illustrated in the block diagram 500 may start at 502A and may be performed by any computing system, apparatus, or device, such as by the system 102 of FIG. 1 or the processor 202 of FIG. 2. Although illustrated with discrete blocks, the exemplary operations associated with one or more blocks of the block diagram 500 may be divided into additional blocks, combined into fewer blocks, or eliminated, depending on the particular implementation

At 502A, a parent record determination operation may be executed. In the parent record determination operation, the system 102 may be configured to determine whether or not a parent record exists in a table associated with the process workflow. The determination may be based on the received first input. The parent record may be required to trigger the process workflow.

At 502B, a configuration data determination operation may be performed. In the configuration data determination operation, the system 102 may be configured to determine whether the configuration data for the record creation activity is included in a record generator table. The system 102 may determine the configuration information about the inclusion of the record creation activity based on the determination that the parent record does not exist in the table. As discussed above, the configuration data may include the name of the table in which the record is to be inserted, the process definition of the process workflow, the name of the record creation activity, the name of the record creation form, and the one or more template fields to be provided in the record creation form.

At 502C, a data extraction operation may be performed. In the data extraction operation, the system 102 may be configured to extract the process execution data from the one or more database tables 106A. The process execution data may be part of the process definition of the process workflow. The process definition may be required to execute the process workflow and may be extracted based on a determination that the configuration data is included in the record generator table.

The process execution data may include a set of lanes and the activities of the process workflow. Each lane of the set of lanes may represent one stage of a process and may include one or more activities associated with the process. The one or more activities in each lane may be grouped in a logical way.

At 502D, a graph construction operation may be performed. In the graph construction operation, the system 102 may be configured to construct an object graph based on the extracted process execution data. The object graph may be a view of the activities at a particular point in time and may be a directed graph. A state of each activity in the constructed object graph may be marked as “pending”.

At 502E, an activity insertion operation may be performed. In the activity insertion operation, the system 102 may be configured to insert the record creation activity as an initial activity in the constructed object graph. The initial activity may be executed as part of the process definition of the process workflow, based on the reception of the first input. The system 102 may be configured to include the record creation form 410 on the rendered second UI 406 based on the insertion of the record creation activity in the object graph. Details about the record creation form 410 are provided, for example, in FIG. 3, and FIG. 4.

FIG. 6A is a diagram that illustrates an example second user interface (UI), according to at least one embodiment described in the present disclosure. FIG. 6A is explained in conjunction with elements from FIGS. 1, 2, 3, 4, and 5. With reference to FIG. 6A, there is shown an example second UI 600A. With reference to FIG. 6A, there is shown a first portion 602 and a second portion 604 within the example second UI 600A. The first portion 602 may represent a set of lanes of the process workflow and the second portion 604 may represent the activities within the corresponding lanes. As an example, the set of lanes may include a first lane labelled as “Assign”, a second lane labelled as “Create”, and a third lane labelled as “Review”. The first lane may have three (3) activities, the second lane may have two (2) activities, and the third lane may have three (3) activities. In some cases, the first lane may have only 2 activities i.e. “Simple task” and “Wait for Interaction Assignment” (show in in the second portion 604) that may be configured by the process owner or process manager of the process. The initial activity i.e. “Select Interaction Type” may be the record creation activity that may be dynamically inserted in the activities of the process workflow by the system 102 based on the reception of the configuration data, as described in FIG. 3.

The system 102 may be configured to receive the first input associated with a record creation activity via the first UI 404 on the electronic device 402. The record creation activity may be required to trigger the process workflow. The system 102 may be configured to extract the process execution data associated with the process workflow and the configuration data associated with the record creation activity from the one or more database tables 106A. The extraction may be performed based on the received first input.

The system 102 may be configured to control the electronic device to render the example second UI 600A based on the process execution data and the configuration data. The second UI includes a record creation form 606 and a set of UI elements 608 to represent activities associated with the process workflow in the pending state of execution. In an embodiment, the record creation form 606 may be included within the second portion 604 of the example second UI 600A and the set of UI elements 608 may be included in both the first portion 602 and the second portion 604 of the example second UI 600A. For example, a first UI element 608A of the set of UI elements 608 may indicate that the record creation activity is “In Progress”. A second UI element 608B may be associated with the second activity within the first lane and may indicate that the second activity is in a “Pending” state. Also, a third UI element 608C associated with the first lane may represent “0%” progress within the first lane and a fourth UI element 608D associated with the first lane may represent that 0 out of 3 activities (“0 out of 3 complete”) in the first lane have been completed at current time.

The system 102 may further receive a second input via the record creation form of the second UI 600. Based on the reception of the second input, the system 102 may trigger execution of the activities.

It should be noted here that the UI elements shown in FIG. 6A are presented merely as examples and such examples should not be construed as limiting the disclosure. The present disclosure may include more or less UI elements and the appearance, position, and UI type may differ in comparison to the UI elements shown in FIG. 6A, without departing from the scope of the disclosure.

FIG. 6B is a diagram that illustrates an example second user interface (UI) with updated set of UI elements, according to at least one embodiment described in the present disclosure. FIG. 6B is explained in conjunction with elements from FIGS. 1, 2, 3, 4, 5, and 6A. With reference to FIG. 6B, there is shown an example second UI 600B that may be displayed on the electronic device 104 based on reception of the second input. With reference to FIG. 6B, there is shown a first portion 602 and a second portion 604. The first portion 602 may represent a set of lanes of the process workflow and the second portion 604 may represent the activities within the corresponding lane.

Based on the triggered execution of the activities, the system 102 may be configured to update the set of UI elements 608 on the example second UI 600B. The set of UI elements 608 may be updated to represent at least one of the activities in an executional state. In an embodiment, the set of UI elements 608 may be updated to represent that at least one of the activities has been executed completely. For example, the first UI element 608A of the set of UI elements 608 may indicate that the record creation activity is “Complete” after the triggered execution. Similarly, the second UI element 608B may indicate that the second activity within the first lane is “In Progress”. The third UI element 608C associated with the first lane may represent a “33%” progress and the fourth UI element 608D associated with the first lane may represent that 1 out of 3 activities (“1 out of 3 complete”) in the first lane have been completed at the current time.

It should be noted here that the UI elements shown in FIG. 6B are presented merely as examples and such examples should not be construed as limiting the disclosure. The present disclosure may include more or less UI elements and the appearance, position, and UI type may differ in comparison to the UI elements shown in FIG. 6B, without departing from the scope of the disclosure.

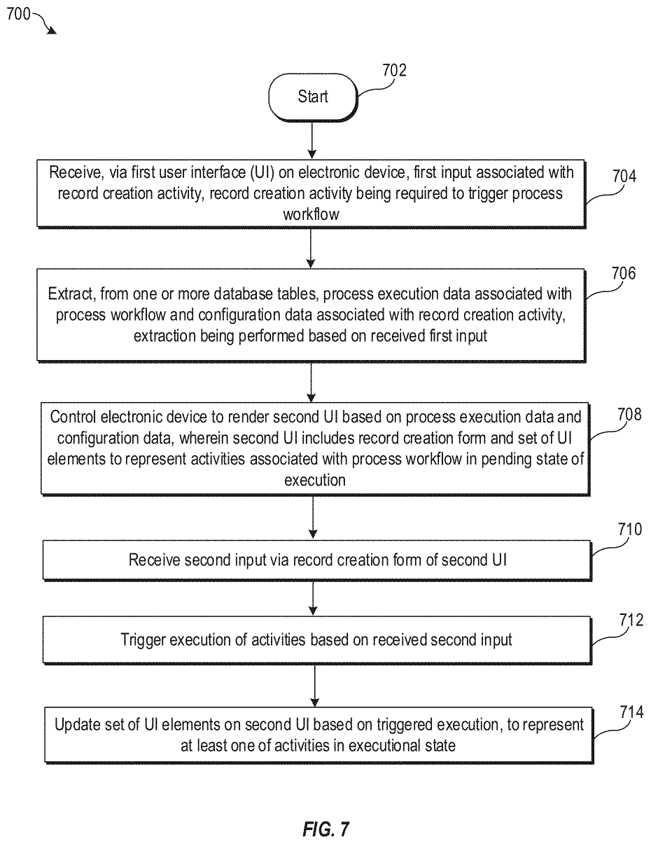

FIG. 7 is a flowchart that illustrates an exemplary method for record generation for execution of process workflows, in accordance with an embodiment of the disclosure. FIG. 6 is described in conjunction with elements from FIGS. 1, 2, 3, 4, 5, 6A, and 6B. With reference to FIG. 7, there is shown a flowchart 700. The exemplary method of the flowchart 700 may be executed by any system, for example, by the system 102 of FIG. 1 or the processor 202 of FIG. 2. The exemplary method of the flowchart 700 may start at 702 and proceed to 704.

At 704, the first input associated with the record creation activity may be received. The first input may be received via the first UI 114 on the electronic device 104. The record creation activity may be required to trigger the process workflow. In one or more embodiments, the system 102 may be configured to receive, via the first user interface (UI) on an electronic device, the first input associated with a record creation activity, the record creation activity being required to trigger a process workflow. Details about the first input are provided, for example, in FIG. 1 and FIG. 4.

At 706, the process execution data associated with the process workflow and configuration data associated with the record creation activity may be extracted from the one or more database tables 106A. The extraction may be performed based on the received first input. In one or more embodiments, the system 102 may be configured to extract, from the one or more database tables 106A, the process execution data associated with the process workflow and the configuration data associated with the record creation activity, the extraction being performed based on the received first input. Details about the extraction of the process execution data and the configuration data are provided, for example, in FIG. 1, and FIG. 5.

At 708, the electronic device 104 may be controlled. The electronic device may be controlled to render the second UI 116 based on the process execution data and the configuration data. The second UI 116 includes the record creation form 118 and the set of UI elements 120 to represent activities associated with the process workflow in the pending state of execution. In one or more embodiments, the system 102 may be configured to control the electronic device 104 to render the second UI 116 based on the process execution data and the configuration data, wherein the second UI 116 includes the record creation form 118 and the set of UI elements 120 to represent activities associated with the process workflow in the pending state of execution. Details about the second UI 116 are provided, for example, in FIG. 1, FIG. 4 and FIG. 6A.

At 710, the second input may be received. The second input may be received via the record creation form 118 of the second UI 116. In one or more embodiments, the system 102 may be configured to receive the second input via the record creation form 118 of the second UI 116. Details about the reception of the second input are provided, for example, in FIG. 1 and FIG. 4.

At 712, the execution of activities may be triggered based on the received second input. In one or more embodiments, the system 102 may be configured to trigger the execution of the activities based on the received second input.

At 714, the set of UI elements 120 may be updated on the second UI 116 based on the triggered execution. The set of UI elements 120 may be updated to represent at least one of the activities in the executional state. In one or more embodiments, the system 102 may be configured to update the set of UI elements 120 on the second UI 116 based on the triggered execution to represent at least one of the activities in the executional state. Details about updating of the set of UI elements 120 are provided, for example, in FIG. 4, and FIG. 6B. Control may pass to end.

Although the flowchart 700 is illustrated as discrete operations, such as 702, 704, 706, 708, 710, 712, and 714, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer-readable medium and/or storage medium having stored thereon, computer-executable instructions executable by a machine and/or a computer to operate a system (e.g., the system 102) for record generation for execution of process workflows. The computer-executable instructions may cause the machine and/or computer to perform operations that may include receiving, via a first user interface (UI) (e.g., the first UI 114) on an electronic device (e.g., the electronic device 104), a first input associated with a record creation activity. The record creation activity may be required to trigger a process workflow. The operations further include extracting, from one or more database tables (e.g., the one or more database tables 106A), process execution data associated with the process workflow and configuration data associated with the record creation activity. The extraction may be performed based on the received first input. The operations may further include controlling the electronic device to render a second UI (e.g., the second UI 116) based on the process execution data and the configuration data. The second UI may include a record creation form (e.g., the record creation form 118) and a set of UI elements (e.g., the set of UI elements 120) to represent activities associated with the process workflow in a pending state of execution. The operations may further include receiving a second input via the record creation form of the second UI. The operations may further include triggering execution of the activities based on the received second input and update the set of UI elements on the second UI based on the triggered execution to represent at least one of the activities in an executional state.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively, or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long-term storage, like ROM, optical or magnetic disks, solid state drives, compact disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures. While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

What is claimed is:

1. A method, comprising:
receiving, via a first user interface (UI) on an electronic device, a first input associated with a record creation activity, the record creation activity being required to trigger a process workflow;
extracting, from one or more database tables, process execution data associated with the process workflow and configuration data associated with the record creation activity, the extraction being performed based on the received first input;
controlling the electronic device to render a second UI based on the process execution data and the configuration data,
wherein the second UI includes a record creation form and a set of UI elements to represent activities associated with the process workflow in a pending state of execution;
receiving a second input via the record creation form of the second UI;
triggering execution of the activities based on the received second input; and
updating the set of UI elements on the second UI based on the triggered execution, to represent at least one of the activities in an executional state.

2. The method according to claim 1, wherein the process execution data is part of a process definition of the process workflow.

3. The method according to claim 1, further comprising:
generating a record based on the second input; and
inserting the generated record as a parent record in a table associated with the process workflow, wherein the execution is triggered further based on the insertion of the record.

4. The method according to claim 3, wherein the configuration data is extracted from a record generator table of the one or more database tables, and the configuration data comprises:
a name of the table in which the record is to be inserted,
a process definition of the process workflow,
a name of the record creation activity,
a name of the record creation form, and
one or more template fields to be provided in the record creation form.

5. The method according to claim 4, further comprising:
receiving a first admin input via a record generator configuration UI rendered on an administrator device; and
updating the record generator table with the configuration data, based on the first admin input.

6. The method according to claim 1, further comprising:
determining, based on the received first input, whether or not a parent record exists in a table associated with the process workflow, the parent record being required to trigger the process workflow;
determining whether the configuration data for the record creation activity is included in a record generator table, based on the determination that the parent record does not exist in the table; and
extracting the process execution data comprising a set of lanes and the activities of the process workflow,
wherein the process execution data is extracted based on a determination that the configuration data is included in the record generator table.

7. The method according to claim 6, further comprising:
constructing an object graph based on the process execution data; and
inserting the record creation activity, as an initial activity, in the object graph,
wherein the record creation form is included on the rendered second UI based on the insertion of the record creation activity in the object graph.

8. The method according to claim 1, wherein the record creation form comprises a form view that includes:
a name of the record creation activity,
one or more template fields comprising at least one pre-filled entry, and
a button UI element that is a declarative action to submit the record creation form, wherein the execution is triggered based on a selection of the button UI element.

9. The method according to claim 8, further comprising:
receiving a second admin input associated with a configuration of the button UI element, wherein the configuration of the button UI element is associated with one of a list of actions to be executed on a selection of the button UI element; and
configuring the button UI element based on the received second admin input.

10. The method according to claim 9, wherein the list of actions comprises at least one of a set of user interface (UI) actions, a set of client actions, and a set of server actions.

11. A non-transitory computer-readable storage medium configured to store instructions that, in response to being executed, causes a system to perform operations, the operations comprising:
receiving, via a first user interface (UI) on an electronic device, a first input associated with a record creation activity, the record creation activity being required to trigger a process workflow;
extracting, from one or more database tables, process execution data associated with the process workflow and configuration data associated with the record creation activity, the extraction being performed based on the received first input;
controlling the electronic device to render a second UI based on the process execution data and the configuration data,
wherein the second UI includes a record creation form and a set of UI elements to represent activities associated with the process workflow in a pending state of execution;
receiving a second input via the record creation form of the second UI;
triggering execution of the activities based on the received second input; and
updating the set of UI elements on the second UI based on the triggered execution, to represent at least one of the activities in an executional state.

12. The non-transitory computer-readable storage medium according to claim 11, wherein the process execution data is part of a process definition of the process workflow.

13. The non-transitory computer-readable storage medium according to claim 11, wherein the operations further comprise:
generating a record based on the second input; and
inserting the generated record as a parent record in a table associated with the process workflow, wherein the execution is triggered further based on the insertion of the record.

14. The non-transitory computer-readable storage medium according to claim 13, wherein the configuration data is extracted from a record generator table of the one or more database tables, and the configuration data comprises:
a name of the table in which the record is to be inserted,
a process definition of the process workflow,
a name of the record creation activity,
a name of the record creation form, and
one or more template fields to be provided in the record creation form.

15. The non-transitory computer-readable storage medium according to claim 14, wherein the operations further comprise:
receiving a first admin input via a record generator configuration first UI rendered on an administrator device; and
updating the record generator table with the configuration data, based on the first admin input.

16. The non-transitory computer-readable storage medium according to claim 11, wherein the operations further comprise:
determining, based on the received first input, whether or not a parent record exists in a table associated with the process workflow, the parent record being required to trigger the process workflow;
determining whether the configuration data for the record creation activity is included in a record generator table, based on the determination that the parent record does not exist in the table; and
extracting the process execution data comprising a set of lanes and the activities of the process workflow,
wherein the process execution data is extracted based on a determination that the configuration data is included in the record generator table.

17. The non-transitory computer-readable storage medium according to claim 16, wherein the operations further comprise:
constructing an object graph based on the process execution data; and
inserting the record creation activity, as an initial activity, in the object graph,
wherein the record creation form is included on the rendered second UI based on insertion of the record creation activity in the object graph.

18. The non-transitory computer-readable storage medium according to claim 16, wherein the record creation form comprises a form view that includes:
a name of the record creation activity,
one or more template fields comprising at least one pre-filled entry, and
a button UI element that is a declarative action to submit the record creation form, wherein the execution is triggered based on a selection of the button UI element.

19. The non-transitory computer-readable storage medium according to claim 18, wherein the operations further comprise:
receiving a second admin input associated with a configuration of the button UI element, wherein the configuration of the button UI element is associated with one of a list of actions to be executed on selection of the button UI element; and
configuring the button UI element based on the received second admin input.

20. A system, comprising:
a processor configured to:
receive, via a first user interface (UI) on an electronic device, a first input associated with a record creation activity, the record creation activity being required to trigger a process workflow;
extract, from one or more database tables, process execution data associated with the process workflow and configuration data associated with the record creation activity, the extraction being performed based on the received first input;
control the electronic device to render a second UI based on the process execution data and the configuration data,
wherein the second UI includes a record creation form and a set of UI elements to represent activities associated with the process workflow in a pending state of execution;
receive a second input via the record creation form of the second UI;
trigger execution of the activities based on the received second input; and
update the set of UI elements on the second UI based on the triggered execution, to represent at least one of the activities in an executional state.
